(19) United States
(12) Patent Application Publication
(10) Pub. No.: US 2015/0047571 A1
(43) Pub. Date: Feb. 19, 2015

(54) Absorbent Pad for Animal Waste

(71) Applicant: Linda Mast, Fort Wayne, IN (US)

(72) Inventor: Linda Mast, Fort Wayne, IN (US)

(21) Appl. No.: 13/969,121

(22) Filed: Aug. 16, 2013

(51) Int. Cl. A01K 1/01; A01K 1/015

(52) U.S. Cl. CPC A01K 1/01; A01K 1/0155
USPC 119/172

(57) ABSTRACT

A pad for absorbing liquid waste from animals, said pad comprising: a absorbent layer, said absorbent layer having a pair of opposing sides, said absorbent layer comprising a composite material comprising recycled paper and a crystalline amphoteric compound in powder form; and a substrate layer, said substrate layer comprising a liquid impermeable material, said substrate layer attached to one of said opposing sides of said absorbent layer.

### REFERENCE TO RELATED APPLICATIONS

This application claims priority from U.S. provisional patent application No. 61/850,819 filed Feb. 25, 2013 entitled, “Critter Clean,” which provisional application is hereby incorporated by reference into the present application for letters patent.

### BACKGROUND OF THE INVENTION

1. Field of the Invention

The present invention relates to an animal waste absorption pad or sheet. More specifically, the present invention relates to an animal waste absorption pad for use on the bottom of a pet domicile such as an aquarium, cage, or the like.

2. Description of the Related Art

U.S. Pat. No. 3,626,899 discloses an absorbent material lined on one side thereof with fluid impervious material is impregnated with an odor imparting substance which attracts young dogs to the pads for the purpose of urination and defecation and discourages chewing of the pad by the young dog.

U.S. Pat. No. 3,752,121 discloses a reinforced bottom grooved plastic tray in which is placed disposable pads, each pad comprising a top layer of artificial grass impregnated with an animal attractant, which is adhered to a perforated plastic sheet beneath which is an abosrbant layer backed by an impervious sheet. A container of deodorizer and a plurality of disposable pads may be packaged with each tray.

U.S. Pat. No. 4,250,834 discloses a pet sanitary facility having a stack of a plurality of liquid impervious and a plurality of liquid absorbent layers, interleaved with each other, located below a perforated platform member made of non-liquid adsorbent material. The peripheral portions of the stack may have support means surrounding same to raise the peripheral portions thereof. Spacer and support means is provided between the platform member and the stack.

U.S. Pat. No. 4,715,320 discloses a sanitary receptacle for animal waste matter is created from three concentric hoops and a sheet of thin flexible material. The material, which may be newspaper, is spread over the inner hoop. The newspaper is captured in the annular space between the inner and center hoops by placing the center hoop on top of the newspaper and pushing the center hoop over the inner hoop. After inverting the inner and center hoops and the captured newspaper, the outer hoop is pushed over the newspaper and the center hoop from the side opposite the center hoop, thereby capturing the material between the center and outer hoops. Removing the inner and outer hoops from the assembled sanitary receptacle allows the edges of the newspaper to be brought together to create a sack for disposing of the animal waste matter deposited on the newspaper.

U.S. Pat. No. 4,774,907 discloses a combination of a sorbent pad laminate and a litter device for the collection of animal urine having a bottom sheet layer of moisture impermeable material, overlying the base of the device, an intermediate sorbent layer of material having a high sorbency capacity for urine and a top claw resistant screen. The bottom sheet layer and top screen are bonded to each other along at least a substantial portion of the periphery of the screen. The screen is a urine permeable, flexible member of nonwoven material which is substantially inert to urine, formed of strands randomly fused together at their intersections and having sufficient tear strength to withstand the clawing action of a cat.

U.S. Pat. No. 4,800,677 discloses an animal waste collection pad having a backing sheet of fluid impervious material, a non-woven top sheet thereon. An absorbent pad is disposed on the backing sheet and the pad contains a scent, attractive to dogs. The scent may be provided by a frangible capsule, a micro encapsulated scent incorporated in the pad or a spray applied to the pad. There are tapes or drawstrings attached to the backing sheet for tying the animal waste collection pad into a small compact package for disposal.

U.S. Pat. No. 4,836,141 discloses an odor controlling pet excrement container having a substantially flat pan in which is removably mounted a conforming protective liner of flexible sheet material the liner having a layer of absorptive material and being adapted to contain a layer of litter material if desired. After use, the liner and its contents are removed from the pan and the excrement and litter are sealed within the liner by means of a drawstring. Super absorbent material capable of gelling liquid urine and suitable odor suppressants are incorporated in the liner and its contents.

U.S. Pat. No. 4,840,140 discloses a combination of a litter device for use with cats which has a sorbent pad laminate for the collection of animal urine consisting of a bottom sheet layer of moisture impermeable material in contact with the base and walls of the litter device, an intermediate sorbent layer of material having a high absorbency capacity for urine, a top claw resistant screen and securing device. The securing device removably affixes the sorbent pad laminate to the litter device, thereby preventing the relative movement between the sorbent pad and the litter device which can be caused by the clawing action of an animal.

U.S. Pat. No. 4,852,518 discloses a sorbent pad structure positioned between a protective screening, capable of withstanding the clawing action of a cat, and a moisture impermeable liner. The cat urine is transferred directly from overlying litter particles, through a cat claw resistant screen into a sorbtive-desiccant member of fibers and having high surface area and high urine sorbency. The urine disperses quickly from fiber to fiber in the sorbtive-desiccant member. The moisture impermeable sheet prevents urine from leaving the side of the sorbtive-desiccant member opposite the screen. The screen and the fibers of the sorbtive-desiccant member provide for aeration, thus inhibiting the growth and bacterial action of bacteria as well as the evaporation of the urine from the sorbtive-desiccant member. Consequently, the bacteria die or become dormant thereby preventing significant odor formation.

U.S. Pat. No. 4,869,204 discloses a claw resistant sorbent pad laminate is employed for the collection of animal urine. The laminate includes a bottom sheet layer of moisture impermeable material, an intermediate sorbent layer of material having a high sorbency capacity for urine, a top claw resistant screen means. The laminate is secured to a container by means of securing means around the periphery of the bottom sheet layer. In one embodiment of the invention the securing means is an elasticized area or areas around the periphery of the moisture impermeable material. In an alternate embodiment a drawstring is movably affixed to the periphery of the bottom sheet layer.

U.S. Pat. No. 4,934,316 discloses a litter box liner comprising a rectangular absorbent pad having a waterproof backing sheet provided with absorbent material thereon. Glue lines or spots are provided on the top face thereof for holding the liner in a box-like configuration conforming to the contours of the litter box. Other glue lines or spots are provided on the bottom surface of the backing sheet for adhesively bonding the liner to the litter box.

U.S. Pat. No. 4,949,673 discloses a chamberpot for domestic pets such as dogs and cats, which employs a water-absorptive sheet as placed on a soil bed. The soil bed is surrounded by peripheral walls, one of which is continuous with a sheet containing section for storing a plurality of sheets in a manner to allow the sheets to be drawn therefrom. The above wall defines a sheet draw-out position for guiding the sheet from the sheet containing section to the soil bed. A clamp device is provided which has a frame shape corresponding to the soil bed, and defines a sheet pressing portion on bottom peripheral faces thereof for pressing a sheet on peripheries of the soil bed. This chamberpot facilitates changing of the sheet placed on the soil bed.

U.S. Pat. No. 5,579,722 discloses an absorbent composite panel to be laid on a urination tray for pet animals such as cats, dogs, hamsters, gerbils, mice, guinea pigs, etc., the composite panel comprising a liquid-permeable topsheet, a liquid-impermeable backsheet and a liquid-absorbent core disposed between these two sheets, the absorbent core comprising a plurality of core elements intermittently arranged independently of one another and the top- and backsheets being bonded together over zones defined between each pair of adjacent core elements so that a selected portion of the composite panel may be cut off from the remainder.

U.S. Pat. No. 5,630,376 discloses an absorbent composite panel comprising a liquid-absorbent panel and a liquid-impermeable backsheet, wherein the top surface of the absorbent panel is partially covered along its peripheral edges with a liquid-impermeable overflow barrier strips which are then bonded integrally to the backsheet along their outer side edges and each inner side edge of the overflow barrier strips is spaced by each spacer from the top surface of the absorbent panel by a desired distance.

U.S. Pat. No. 5,715,772 discloses an absorbent pad for animal accessories. The absorbent pad includes an absorbent layer having first and second sides. A one-way moisture barrier in the form of driweave is positioned proximate to at least one side of the absorbent layer. The barrier allows moisture to pass toward the absorbent layer and resists passage of moisture away from the absorbent layer. The several layers are encased in a mesh that protects the pad and provides support thereto for maintaining its shape. The layers may be stitched together to maintain their orientation. Optionally, deodorizer and disinfectant may be applied to the absorbent layer for neutralizing odors created by absorbed animal waste, as well as sanitizing it.

U.S. Pat. No. 5,797,347 discloses an absorbent panel for pet animals such as dogs and cats comprising a liquid-permeable topsheet, a liquid-impermeable backsheet and a liquid-absorbent core panel therebetween, the core panel comprises a relatively thin central region and a relatively thick side region.

U.S. Pat. No. 5,819,688 discloses a pet animal odor absorbing mat comprising a mat or pad formed of a fibrous material, such as a cellulosic material, and which is integrally incorporated with a zeolite mineral during the manufacture of the mat. The pad or mat is primarily based on the cellulosic or other fibrous material such as for example, wood fiber. The wood fibers are mixed with a binding agent such as an acrylic latex or other animal non-toxic binder, and the zeolite while in somewhat of a semi-viscous and semi-liquid state and then allowed to harden. The mat is highly effective for use as a bottom layer in cat litter boxes to absorb both urine or other wetness and highly effective, in literally entrapping odors, such as those odors arising from pet animals. The mat thereupon simultaneously releases oxygen. This type of mineral has been found to be particularly effective in removing those odors arising both from the animal urine, as well as other animal excreta.

U.S. Pat. No. 6,244,216 discloses a sheet for pet excretion including a liquid permeable front face sheet, a liquid impermeable rear face sheet and an absorbent body interposed between the front face sheet and the rear face sheet. A liquid absorbent region where the absorbent body exists has a colored portion positioned at the center thereof and a non-colored portion adjoining the colored portion so as to enclose a whole periphery of the colored portion.

U.S. Pat. No. 6,802,281 discloses an absorbent mat useful for treating pet excreta has a flat shape and comprises an absorbing base material comprising at least one of plant fiber and pulp, an antimicrobial surface active agent or a combination of a surface active agent and an antimicrobial agent, and at least one of a binder, a crosslinking agent and water, the absorbent mat having a thickness of 3 mm or greater, a bulk density of 0.05 to 0.3 g/cm3, a saturated water absorption of 2 g/1 g or more, and a rate of water absorption of 30 sec or shorter.

U.S. Pat. No. 6,976,451 discloses an animal waste collection pad, comprising: a backing sheet of fluid impervious material, one or more absorbent sheets overlying the backing sheet, a top sheet overlying the absorbent sheet(s) and integrated tie means along one dimension of the collection pad. The tie means form ties for carrying and tying the collection pad into a compact bundle for disposal.

U.S. Pat. No. 7,249,570 discloses a training pad having a plurality of material layers to retain fluids and solid material; while preventing passage therethrough. The top layer serves as the absorbent material with the bottom layer forming a fluid impermeable layer to prevent passage of liquids.

U.S. Pat. No. 7,654,227 discloses a layered pad comprising a bottom impervious layer, a top layer of a fibrous high loft non woven capable of entrapping small or large particles and preventing their scatter, optionally combined with a middle layer of fibers and super absorbent agent, wherein liquids pass through the top layer, become absorbed by the middle layer, and evaporate; and a method for manufacturing a non-woven pad layer having an at least partially open-ended configuration. The method of manufacturing the open-ended non-woven layer includes cutting at least one surface of the non-woven layer and then abrading the cut surface with an abrading tool.

U.S. Pat. No. 7,874,266 discloses a waste absorbent material for the treatment of animal waste is provided which may comprise a non-woven pad or litter granules which include micronutrients which may stimulate specific microorganisms and reduce the gases produced by the aerobic and/or anaerobic decomposition of organic matter. The non-woven pad and/or litter may also comprise biodegradable fibers or biodegradable particulate and the micronutrients may be uniformly distributed over the pad surface or within the particulate and be incorporated at a selected thickness.

U.S. Pat. No. 7,891,320 discloses a pet sheet including a topsheet, a backsheet, an absorbent core located between the sheets and a compression molded product of a ground material of plant origin located between the topsheet and the absorbent core. The compression molded product is designed to swell and disintegrate upon water absorption. The compression molded product preferably further contains inorganic powder, particularly zeolite.

U.S. Pat. No. 8,042,489 discloses an animal waste collection sheet is planar and is consisted of a top sheet which is liquid permeable, a back sheet which is liquid impermeable and an absorbent sheet disposed between the top sheet and the back sheet. The top sheet is consisted of a non-woven fabric with convex and concave portions on the surface thereof. The top sheet is preferably a non-woven fabric alternately having a plurality of groove portions and a plurality of convex portions formed in a fixed direction.

U.S. Pat. No. 8,042,490 discloses an planer animal waste collection sheet that consists of a top sheet which is liquid permeable, a back sheet which is liquid impermeable and an absorbent sheet disposed between the top sheet and the back sheet. The top sheet has a high fiber density region in a thickness direction thereof, with a fiber density higher than an average fiber density of the top sheet, at least in a part of a side facing the absorbent sheet. The average fiber density is preferably in the range of 0.005 to 0.20 g/cm3, and a fiber density of the high fiber density region is preferably in the range of 0.007 to 0.25 g/cm3.

U.S. Pat. No. 8,101,815 discloses a pet waste absorption sheet includes a liquid-impermeable backsheet, a liquid-permeable topsheet, and an absorbent core disposed between the backsheet and the topsheet. The topsheet is a resin film formed with a plurality of apertures for passage of liquid. The topsheet is bonded to the absorbent core through a hot-melt type adhesive. The hot-melt type adhesive is applied in a plurality of continuous lines including curved portions.

U.S. Pat. No. 8,468,973 discloses an excretion disposal sheet for pet animals that contains fragrance adapted to develop aroma effectively masking odor of excretion. The fragrance is in the form of a powder compound wherein the fragrance includes cyclodextrin and this particulate compound is sandwiched between an upper surface of a core material and a liquid-pervious sheet in the form of tissue paper overlying the upper surface.

The known prior art, however, does not disclose many features of the present invention including, for example and without limitation, an absorbent pad made using recycled nontoxic paper or a completely non-toxic absorbent pad further comprising an amphoteric powder to reduce odor. Additionally, the present invention provides a low cost, fully biodegradable absorbent pad for liquid animal waste. Other advantages and features of the present invention will be apparent to those of skill in the applicable art of the present invention upon reading the Summary, Drawings, Detailed Description, and Claims herein.

### SUMMARY

The present invention, in one exemplary embodiment, encompasses a pad for absorbing liquid waste from animals, said pad comprising: an absorbent layer, said absorbent layer having a pair of opposing sides, said absorbent layer comprising a composite material comprising recycled paper and a crystalline amphoteric compound in powder form; and a substrate layer, said substrate layer comprising a liquid impermeable material, said substrate layer attached to one of said opposing sides of said absorbent layer.

In another exemplary embodiment, the present invention includes a method of making a pad for absorbing the liquid waste of animals, said method comprising the steps of: providing paper in pulp form; placing said paper pulp in a mold; dehydrating and drying said paper pulp within the mold, thereby creating an absorbent layer; removing said absorbent layer from said mold; and applying a liquid impermeable layer to one side of said absorbent layer.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

FIG. 1 shows a perspective view of an absorbent pad according to the present invention.

FIG. 2 shows a top view of an absorbent pad according to the present invention.

FIG. 3 shows a bottom view of an absorbent pad according to the present invention.

FIG. 4 shows a side view of an absorbent pad according to the present invention.

FIG. 5 shows a side view of the set-up for making an absorbent pad according to the present invention.

FIG. 6 shows a flow chart of the steps for making an absorbent pad according to the present invention.

### DETAILED DESCRIPTION OF EMBODIMENTS

The present invention will be discussed hereinafter in detail in terms of the preferred embodiment according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscuring of the present invention.

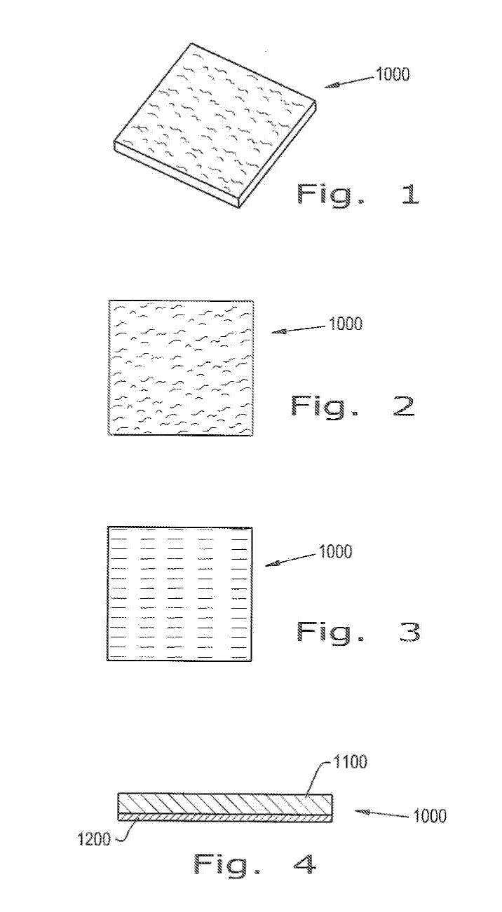

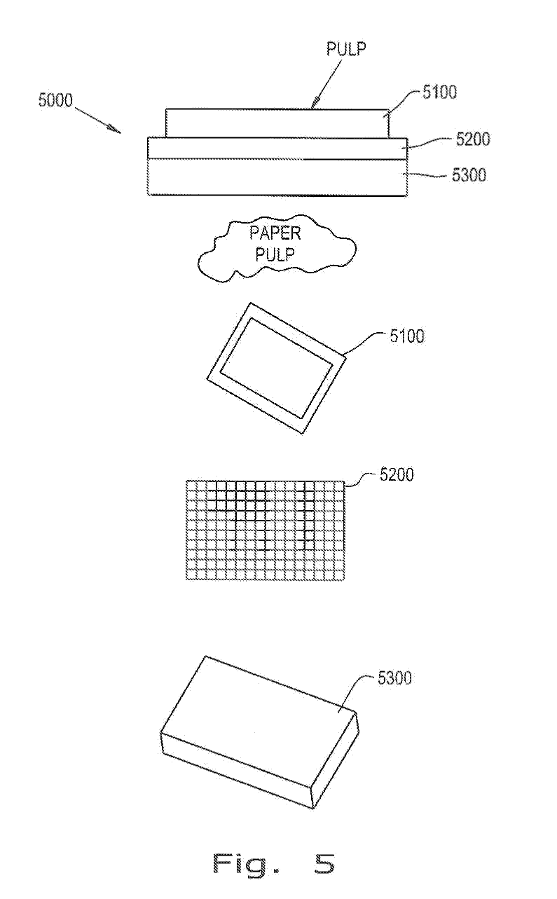

Referring first to FIG. 1, FIG. 2, FIG. 3, and FIG. 4, there is shown a top perspective view, top view, bottom view, and side view, respectively of absorbent pad 1000 according to an embodiment of the present invention. Pad 1000 generally comprises an absorbent layer 1100 and a liquid impermeable layer 1200.

Absorbent layer 1100 of pad 1000 comprises a composite material formed of dehydrated and dried paper mash that has been formed from paper strips or pulp and water and mixed with a functional amount of an amphoteric, crystalline powder such as sodium bicarbonate, potassium bicarbonate, calcium bicarbonate, and ammonium bicarbonate, but preferably sodium bicarbonate.

Paper pulp is a lignocellulosic fibrous material prepared by chemically or mechanically separating cellulose fibres from wood, fibre crops or waste paper. Recycled pulp, however, comprises recycled paper which has been processed by chemicals, thus removing printing inks and other unwanted elements and freed the paper fibres. The process is called deinking.

Preferably, the dried paper mash comprises strips formed from recycled or deinked paper that have been immersed in water and formed into a malleable mash of desired size and consistency. In the exemplary embodiment of the present invention, the paper having the material characteristics of common notebook or printer paper is used. However, those of skill in the art will appreciate, that other paper products can be used within the scope of the present invention by, for example, using more or less water to create the mash.

Referring again to FIG. 4, there is shown a side elevation view of pad 1000 further comprising liquid impermeable layer 1200. Liquid impermeable layer 1200 comprises a plastic or wax that is mechanically or adhesively attached to one side of absorbent layer 1100 as shown in FIG. 4. Preferably, adhesive layer 1200 comprises wax spray.

Referring generally to FIG. 6, there is shown a flow chart of the steps of making pad 1000 in accordance with the present invention. As shown in FIG. 6, the steps of making pad 1000 comprise: providing paper in pulp form: placing said paper pulp in a mold; dehydrating and drying said paper pulp within the mold, thereby creating an absorbent layer; removing said absorbent layer from said mold; and applying a liquid impermeable layer to one side of said absorbent layer.

Referring again to FIG. 6, in a preferred method of making an absorbent pad 1000, one acquires shredded, chopped, or mulched deinked paper. The paper preferably comprises common notebook or printer paper quality and material characteristics. The paper should contain no plastic or other foreign bodies.

Referring generally still to FIG. 6, the paper should be placed in a glass, plastic, or otherwise chemically inert container (not shown) of suitable size. Enough water should be added to the container to cover the paper. Approximately ¼ of a cup of sodium bicarbonate should be added to the paper and water for every ½ gallon of water. The paper, water, and sodium bicarbonate combination should be allowed to soak for 6 to 12 hours, preferably 8 hours. The paper, water, and sodium bicarbonate mixture is then placed into a mixer (not shown) until it achieves the consistency of a wet dough or mash.

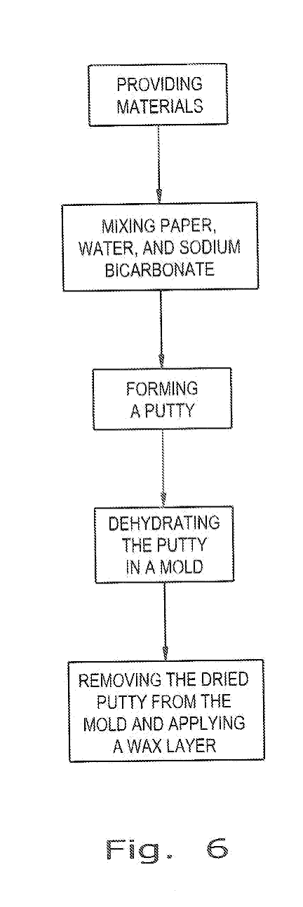

Referring now to FIG. 5, in the method of the present invention, the paper mash should now be placed into a mold 5100 of desired size, shape, surface area, and depth. In an exemplary embodiment of the present invention, the mold is a square or rectangular mold comprising a perimeter with an open top surface and an open bottom surface. Preferably, the mold is about 10 inches long, about 10 inches wide, and about ½ inches in depth to produce pads of 9.75 inches squared, a suitable size to fit into the most popularly sized aquariums and such that the finished product 1000 has a thickness of about to about 1 inch, but preferably about inch.

As shown in FIG. 5, the paper mash is placed within mold 5100 and atop a preferably flat, preferably wooden sheet 5300. A drying screen 5200 is disposed between mold 5100 and wooden sheet 5300. The paper mash is mechanically manipulated, for example by rolling, until it has the desired distribution within the mold.

Referring again to FIG. 5, the combination of mold 5100, drying screen 5200, and wooden sheet 5300 make up drying rack 5000.

In one exemplary method, as shown in FIG. 6, the paper mash, mold 5100, screen 5200, and sheet 5300 are placed into a dehydrator (not shown) for 2-4 hours until the paper mash is dry. Once the paper mash is molded and dry, it is removed from mold 5100 thereby creating absorbent layer 1100. A plastic or wax coating is then applied to one side of absorbent layer 1100 to form liquid impermeable layer 1200. In one exemplary method, a paraffin wax is sprayed on one side of the now dried and molded paper mash to form liquid impermeable layer 1200.

### EXAMPLES

For testing purposes, the present inventor made two sample products in accordance with the present invention. Both samples were tested on May 22, 2013 at the Northeast Indiana Small Business Development Center by observing the effects of adding ⅙ cup of water to the product in 15 minute increments over the course of an hour.

The first product sample performed as follows:

| Time | Action | Observation |
|---|---|---|
| 0:00 | Added ⅙ cup of water. | No leak through or around the |
| | | product sample |
| 0:15 | Added ⅙ cup of water. | No leak through or around the |
| | | product sample |
| 0:30 | Added ⅙ cup of water. | No leak through or around the |
| | | product sample |
| 0:45 | Added ⅙ cup of water. | No leak through or around the |
| | | product sample |
| 0:60 | Added ⅙ cup of water. | No leak through or around the |
| | | product sample |

In a second test of the exemplary embodiment described herein, a product made in accordance with the present invention performed as follows:

| Time | Action | Observation |
|---|---|---|
| 0:00 | Added ⅙ cup of water. | No leak through or around the |
| | | product sample |
| 0:15 | Added ⅙ cup of water. | No leak through or around the |
| | | product sample |
| 0:30 | Added ⅙ cup of water. | No leak through or around the |
| | | product sample |
| 0:45 | Added ⅙ cup of water. | No leak through or around the |
| | | product sample |
| 0:60 | Added ⅙ cup of water. | No leak through or around the |
| | | product sample |

Although the present invention has been illustrated and described with respect to exemplary embodiments thereof, it should be understood by those skilled in the art that the foregoing and various other changes, omission and additions may be made therein and thereto, without departing from the spirit and scope of the present invention. Therefore, the present invention should not be understood as limited to the specific embodiments set out above but should be understood to include all possible embodiments which can be embodied within a scope encompassed and equivalent thereof with respect to the feature set out in the appended claims.

1. A pad for absorbing liquid waste from animals, said pad comprising:
a. a absorbent layer, said absorbent layer having a pair of opposing sides, said absorbent layer comprising a composite material comprising recycled paper and a crystalline amphoteric compound in powder form; and
b. a substrate layer, said substrate layer comprising a liquid impermeable material, said substrate layer attached to one of said opposing sides of said absorbent layer.

2. The waste pad of claim 1, wherein the crystalline amphoteric compound powder is selected from the group consisting of sodium bicarbonate, potassium bicarbonate, calcium bicarbonate, and ammonium bicarbonate.

3. The waste pad of claim 1, wherein the crystalline amphoteric compound powder is sodium bicarbonate.

4. The waste pad of claim 1, wherein the liquid impermeable layer comprises a biodegradable material.

5. The waste pad of claim 1, wherein the liquid impermeable layer comprises a non-toxic, biodegradable material.

6. The waste pad of claim 1, wherein the liquid impermeable material comprises wax.

7. The waste pad of claim 1, wherein the liquid impermeable material comprises an organic polymer.

8. The waste pad of claim 1, wherein the substrate layer is adhesively attached to said absorbent layer.

9. The waste pad of claim 1, wherein the substrate layer is mechanically attached to said absorbent layer.

10. The waste pad of claim 1, wherein the pad further comprises a thickness, said thickness of at least about 0.20 inch.

11. The waste pad of claim 1, wherein the pad further comprises a thickness, said thickness of at least about 0.25 inch.

12. The waste pad of claim 1, wherein the pad further comprises a thickness, said thickness of at least about 0.33 inch.

13. The waste pad of claim 1, wherein the pad further comprises a thickness, said thickness within a range of from about 0.20 inch to 1 inch.

14. The waste pad of claim 1, wherein the pad further comprises a thickness, said thickness within a range of from about 0.25 inch to 1 inch.

15. The waste pad of claim 1, wherein the pad further comprises a thickness, said thickness within a range of from about 0.33 inch to 1 inch.

16. The waste pad of claim 1, where the pad absorbs at least about ⅔ cup of liquid/hour and where the pad comprises a thickness of about ¼ inch and a surface area of about 9.75 inches squared.

17. A method of making a pad for absorbing the liquid waste of animals, said method comprising the steps of:
a. Providing paper in pulp form;
b. Placing said paper pulp in a mold;
c. Dehydrating and drying said paper pulp within the mold, thereby creating an absorbent layer;
d. Removing said absorbent layer from said mold; and
e. Applying a liquid impermeable layer to one side of said absorbent layer.

18. The method of claim 17, wherein the step of applying a liquid impermeable layer to the absorbent layer comprises spraying a wax film to one side of the absorbent layer.
